(19) United States
(12) Patent Application Publication
(10) Pub. No.: US 2023/0039570 A1
(43) Pub. Date: Feb. 9, 2023

(54) MICROPHONE

(71) Applicant: Shenzhen Huasirui Technology Co., Ltd., Shenzhen (CN)

(72) Inventor: BING YANG, Shenzhen (CN)

(21) Appl. No.: 17/396,744

(22) Filed: Aug. 8, 2021

(51) Int. Cl. H04R 1/02; H04R 1/04; H04R 1/34; F21S 10/02; F21V 23/00; H05B 45/10

(52) U.S. Cl. CPC H04R 1/028; H04R 1/04; H04R 1/345; F21S 10/02; F21V 23/003; H05B 45/10; H04R 2420/07; F21Y 2115/10

(57) ABSTRACT

This application discloses a microphone that includes a handle portion, a control portion, and a microphone head that are connected in sequence. The control portion includes a first circuit board and multiple light-emitting assemblies arranged along a perimeter of the control portion. The first circuit board is electrically connected to the multiple light-emitting assemblies for controlling the multiple light-emitting assemblies to emit light in a preset light-emitting mode. In the solution of this application, multiple light-emitting assemblies are arranged in the control portion, so that when in use, the color of the light and the brightness of the light-emitting assembly can be automatically changed according to the microphone song or through a control button, so that the multiple light-emitting assemblies of the microphone can illuminate in a preset manner.

### TECHNICAL FIELD

This application relates to the technical field of audio equipment, and more particularly relates to a microphone.

### BACKGROUND

With the improvement of the national economy and living standards, people's pursuit of artistic life has gradually increased. Music, as one of the art forms that can impress people most immediately, has flourished in modern society. The microphone speaker, as one of the carriers of music, has gradually gained popularity. The microphone speaker is a commonly used audio input and output device with a wide range of applications. It operates by the principle that the audio signal collected by the microphone is processed, modulated and transmitted at the frequency to be transmitted, and then received by the corresponding receiver, and then after a series of processing, the audio signal is demodulated, and the sound is restored through the loudspeaker.

However, the current wireless microphones have a dull design and can only serve a single function, and there is no decoration hence lack of aesthetics. When it is used in an environment with poor lighting conditions, there is no outstanding visual display effect, which is only monotonous so that the singer can easily feel aesthetic fatigue. It is unable to provide the appropriate rendering lighting that matches the style of the song, and so cannot create a good singing atmosphere, thus reducing the comfort of use by the singer. Furthermore, most wireless microphones have an unsatisfactory sound effect with significant noise, which spoils the singer's singing experience.

### SUMMARY

This application provides a microphone to solve the above technical problems.

In order to solve the above technical problems, a technical solution adopted in this application is to provide a microphone, which includes a handle portion, a control portion, and a microphone head that are sequentially connected;

where the control portion includes a first circuit board and a plurality of light-emitting assemblies arranged along a perimeter of the control portion;

and the first circuit board is electrically connected to the plurality of light-emitting assemblies for controlling the plurality of light-emitting assemblies to emit light in a preset light-emitting mode.

Optionally, the control portion includes two sets of parallel side surfaces, and at least one of the side surfaces is provided with the light-emitting assemblies.

Optionally, the control portion further includes a top surface and a bottom surface that are arranged in parallel, and both the top surface and the bottom surface are connected to the two sets of parallel side surfaces.

Further, at least one of the top surface or the bottom surface is provided with the light emitting element.

Optionally, each of the side surfaces of the control portion is provided with the light-emitting assembly.

Optionally, the control portion further includes a control button that is electrically connected to the first circuit board and that is used to control the light-emitting mode of the plurality of light-emitting assemblies.

where the light-emitting mode of the plurality of light-emitting assemblies comprises: the plurality of light-emitting assemblies emit light in sequence; or

the multiple light-emitting assemblies include multiple light-emitting elements of different colors, and the light-emitting mode includes that the light-emitting elements of different colors emit light sequentially.

Optionally, the microphone further includes a protective mesh cover sleeved on the control portion, and the light-emitting assemblies are exposed through the meshes of the protective mesh cover.

Optionally, the light-emitting assembly includes a second circuit board and a light-emitting element arranged on the second circuit board;

where the light-emitting element is a light-emitting diode.

Optionally, the handle portion includes a power supply assembly and a charging interface, where the power supply assembly is electrically connected to the first circuit board and the light-emitting assemblies for supplying power to the first circuit board and the light-emitting assemblies; and

the charging interface is electrically connected to the power supply assembly, and is used to electrically connect to an external power source to charge the power supply assembly.

Optionally, the control portion further includes a sound cavity, where a loudspeaker is arranged in the sound cavity and is electrically connected to the first circuit board.

Optionally, the microphone head includes a support seat, a mic net cover, a mic holder, and a mic element. The support seat is connected to the sound cavity, and the mic holder is connected to the side of the support seat away from the sound cavity. The microphone is installed on a side of the mic holder away from the sound cavity, and the mic net cover at least covers on the mic element.

This application may provide the following benefits. According to the solutions of this application, multiple light-emitting assemblies are arranged in the control portion. When in use, the color of the light emitted by the light-emitting assembly and the brightness of the light-emitting assembly can be automatically changed according to the microphone song or through the control button, so that the multiple light-emitting assemblies of the microphone can illuminate in a preset manner, thereby improving the aesthetics of the microphone when in use, and providing rich visual effects. In addition, when the user uses this microphone to sing, the atmosphere during singing can be effectively increased, so that the comfort of the singer and the listener is enhanced, leading to high market competitiveness and practicability, Furthermore, in the solution of the present application, by setting the diaphragm and the mic holder, when the loudspeaker is working, the air vibration in the sound cavity of the microphone can resonate with the diaphragm, thus enhancing the three-dimensional sensation of the music when the singer sings. The mic holder can effectively reduce the howling in the sound, reduce the noise, improve the purity of the sound of singing, increase the sound effect, and provide a better singing experience for the singer.

### BRIEF DESCRIPTION OF DRAWINGS

For a clearer understanding of the technical solutions that are used in the embodiments according to the present disclosure, hereinafter the drawings that are required for the description of the embodiments disclosed herein will be briefly introduced. Apparently, the drawings in the following description merely represent some embodiments of the present disclosure, and for those having ordinary skill in the art, other drawings may also be obtained based on these drawings without investing creative efforts.

FIG. 1 is a schematic diagram illustrating an embodiment of a microphone provided by the present application.

FIG. 2 is an exploded view of the microphone shown in FIG. 1.

FIG. 3 is a cross-sectional view of the microphone shown in FIG. 1.

FIG. 4 is a schematic diagram illustrating the structure of the control portion of the microphone shown in FIG. 1 with the protective mesh cover removed.

FIG. 5 is a schematic diagram illustrating the structure of the microphone shown in FIG. 1 with the upper transparent cover removed.

FIG. 6 is a schematic diagram illustrating the structure of the microphone shown in FIG. 1 with the upper transparent cover removed.

FIG. 7 is a schematic diagram illustrating the structure of the microphone shown in FIG. 4 after further removing the light-emitting assemblies.

FIG. 8 is an exploded view of the microphone shown in FIG. 4.

### DETAILED DESCRIPTION

Hereinafter, technical solutions in the embodiments according to the present application will be described in a definite and comprehensive manner in connection with the accompanying drawings in the embodiments according to the disclosure. Apparently, the embodiments described herein are only a part, rather than all of the embodiments in accordance with the present application. On the basis of the embodiments of the present application, all other embodiments obtained by those having ordinary skill in the art without investing creative efforts shall all fall in the scope of protection of the present application.

It should be noted that any directional or orientational indication (such as up, down, left, right, front, back . . . ) as used in the embodiments disclosed herein is merely used to explain the relative positional relationships and movement of the components in a specific posture (as shown in the figures). Should the particular posture changes, the directional or orientational indication would also change accordingly.

In addition, terms “first”, “second”, or the like as used herein are merely used for illustrative purposes, and shall not be construed as indicating relative importance or implicitly indicating the number of technical features specified. Thus, unless otherwise specified, the features defined by “first” and “second” may explicitly or implicitly include at least one of such feature. In addition, the technical solutions according to the various embodiments can be combined with each other, but it must be based on what can be achieved by a person having ordinary skill in the art. When the combination of technical solutions is conflicting or cannot be achieved, it should be considered that such a combination of technical solutions does not exist, nor does it fall in the scope of protection of the present disclosure.

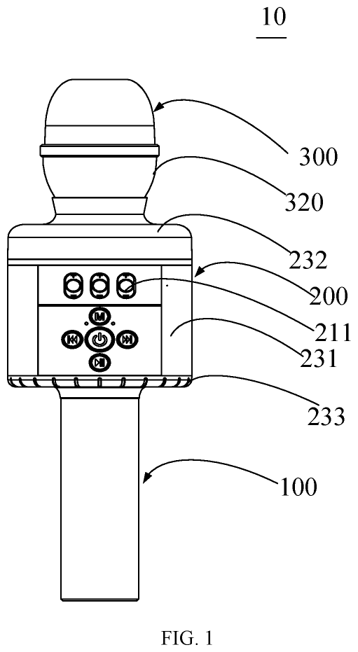

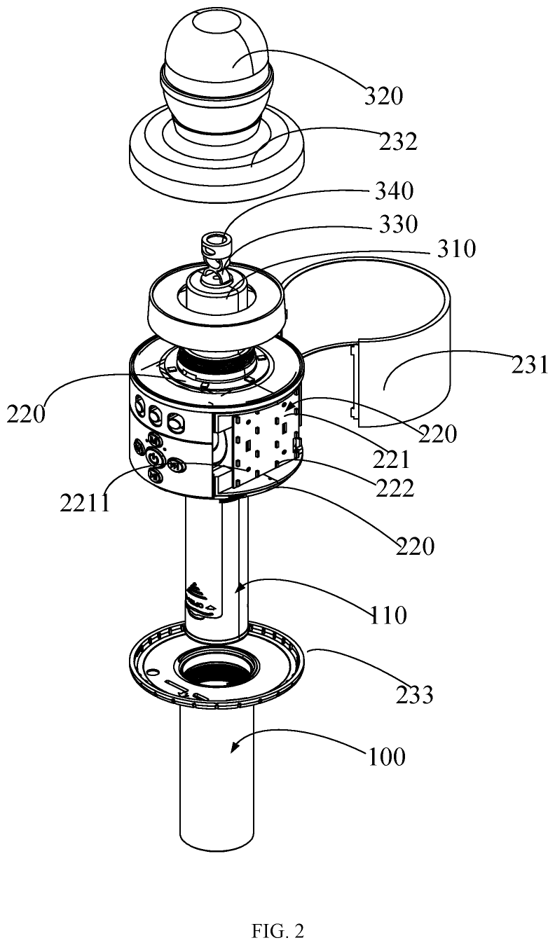

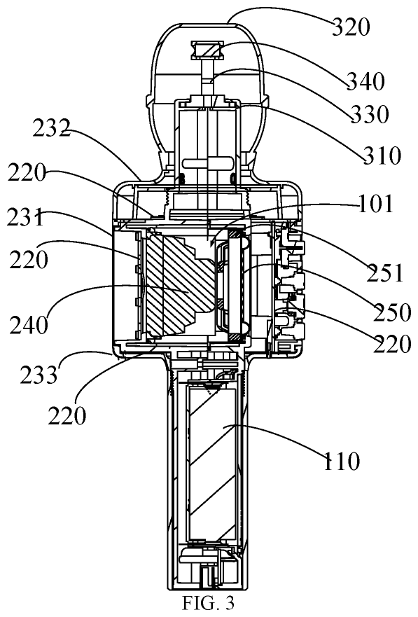

Referring to FIGS. 1-3. FIG. 1 is a schematic diagram of an embodiment of a microphone provided by the present application. FIG. 2 is an exploded view of the microphone shown in FIG. 1. FIG. 3 is a cross-sectional view of the microphone shown in FIG. 1.

The microphone 10 includes a handle portion 100, a control portion 200, and a microphone head 300 that are sequentially connected.

When the microphone 10 is in use, the handle portion 100 can be held by the user, and the microphone head 300 can be used to face towards the user's mouth. When the user is speaking or singing, the microphone head 300 can resonate with the emitted sound so as to generate a fluctuating current signal corresponding to the user's utterance, and then operate in cooperation with the loudspeaker in the microphone 10 to convert the fluctuating current signal into a corresponding sound and send it.

In this embodiment, the control portion 200 is disposed between the handle portion 100 and the microphone head 300.

The control portion 200 includes a first circuit board (not shown in the figures) and a plurality of light-emitting assemblies 220.

A preset control circuit may be formed on the first circuit board, and the first circuit board may be electrically connected to the multiple light-emitting assemblies 220, so that the multiple light-emitting assemblies 220 can be controlled to be electrically connected to emit light in a preset light-emitting mode.

Specifically, the light emitting mode of the plurality of light emitting assemblies 220 may include, but is not limited to, the following solutions.

Solution 1: The first circuit board can control the multiple light-emitting assemblies 220 to emit light in sequence. For example, say the light-emitting assemblies 220 come in the number of three, then the first circuit board can control the three light-emitting assemblies 220 to illuminate in succession. The sequential illumination here may mean that only one light-emitting assembly 220 is turned on at a time and three light-emitting assemblies 220 take turns to emit light in sequence; or, it may also be that one of the light-emitting assemblies 220 is controlled to emit light, and then another light-emitting assembly 220 is added to emit light (at this time, two light-emitting assemblies 220 emit light), and then a third light-emitting assembly 220 is further added to emit light.

The light-emitting sequence of the multiple light-emitting assemblies 220 and the number of light-emitting assemblies can be set as required, which is not further limited herein.

Alternatively or additionally, in other solutions, the first circuit board may also control the multiple light-emitting assemblies 220 to emit light and form a preset pattern. Furthermore, the pattern can be switched according to the style of the song, tune, lyrics, etc. The preset pattern can be set in advance, which is not further limited herein.

Alternatively or additionally, in other solutions, it is also possible to control the on and off of the plurality of light-emitting assemblies 220 to form a luminous effect similar to a breathing lamp, and the on and off of the light-emitting assemblies 220 can be matched with the rhythm of the song.

Solution 2: The multiple light-emitting assemblies 220 may include multiple light-emitting elements of different colors. At this time, the first circuit board can control the light-emitting elements of different colors to emit light sequentially; the sequential light emission described herein can be the same as the solution in Solution 1. This will not be repeated here again.

Further, in other solutions, each light-emitting assembly 220 can emit light of a different color. While controlling the multiple light-emitting assemblies 220 to emit light in the above-mentioned light-emitting mode, the first circuit board may also control each light-emitting assembly 220 to emit light of a preset color as required.

Further, in this embodiment, a function button 211 is also provided on the first circuit board. The function button 211 may be electrically connected to a functional circuit on the first circuit board, and the function button 211 can be used to adjust the light-emitting mode of the multiple light-emitting assemblies 220. As illustrated in FIG. 1, the first circuit board may be arranged on the inner side of the function button 211 and housed in the inner side of the housing of the control portion 200.

For example, in this embodiment, the first circuit board may further include a memory that stores multiple light-emitting modes of the light-emitting assemblies 220, and the user can switch the light-emitting modes of the multiple light-emitting assemblies 220 using the function button 211.

Further referring to FIGS. 1-3, and FIG. 4, which is a schematic diagram of the control portion of the microphone shown in FIG. 1 after the protective mesh cover is removed.

In this embodiment, the control portion 200 may be in the overall shape of a rectangular parallelepiped or a cube (or approximately a rectangular parallelepiped or a cube).

The control portion 200 includes two sets of parallel side surfaces 201, namely includes four side surfaces 201, a top surface 202 and a bottom surface 203.

At least one of the four side surfaces 201 is provided with a light-emitting assembly 220.

In this embodiment, each set of light-emitting assemblies 220 may include a second circuit board 221 and a plurality of light-emitting elements 222, where the plurality of light-emitting elements 222 are all mounted on the second circuit board 221, and the second circuit board 221 may be electrically connected to the first circuit board.

In this embodiment, each side surface 201 may be provided with a set of light emitting assemblies 220, and the second circuit board 221 in the light emitting assemblies 220 on each side surface 201 may be arranged to be parallel to the corresponding side surface 201.

In this embodiment, the light-emitting element 222 may be an LED lamp, which may be soldered on the second circuit board 221.

Further, in this embodiment, the light-emitting assemblies 220 may be provided on both the top surface 202 and the bottom surface 203 of the control portion 200.

Therefore, in this embodiment, at least one of the side surfaces 201, the top surface 202, and the bottom surface 203 of the control portion 200 may be provided with the light-emitting assemblies 220, so that when in use, the color of the light emitted by the light-emitting assembly 220 and the brightness of the light-emitting assembly can be automatically changed according to the microphone song or through the control button, so that the multiple light-emitting assemblies of the microphone can illuminate in a preset manner, thereby improving the aesthetics of the microphone when in use, and providing rich visual effects. In addition, when the user uses this microphone to sing, the atmosphere during singing can be effectively increased, so that the comfort of the singer and the listener is enhanced, leading to high market competitiveness and practicability.

In the above embodiment, the control portion 200 is in overall a rectangular parallelepiped or a cube. In other embodiments, the control portion 200 may alternatively have an overall shape of a cylinder or a cone (or approximately a cylinder or a cone). And in this case, the multiple light-emitting elements 222 in the light-emitting assembly 220 may be uniformly arranged along the perimeter of the control portion 200.

In this solution, a flexible circuit board can be used as the second circuit board 221, and the second circuit board 221 can also be wound along the circumferential direction of the control portion 200.

Further referring to FIG. 1 to FIG. 3.

In this embodiment, the microphone 10 further includes a protective mesh cover 231, an upper transparent cover 232, and a lower transparent cover 233. The protective mesh cover 231 may be arranged around the perimeter of the control portion 200. The upper transparent cover 232 may be covered on the top surface 202 of the control portion 200, and the lower transparent cover 233 may be covered on the bottom surface 203 of the control portion 200. The upper transparent cover 232 and the lower transparent cover 233 are respectively connected to opposite sides of the protective mesh cover 231 so as to form a casing covering the control portion 200.

The light emitted by the light-emitting assemblies 220 on the top surface 202 and the bottom surface 203 can be emitted through the upper transparent cover 232 and the lower transparent cover 233, and the light emitted by the light-emitting assemblies 220 on the side surfaces 201 can be emitted through the mesh of the protective mesh cover 231.

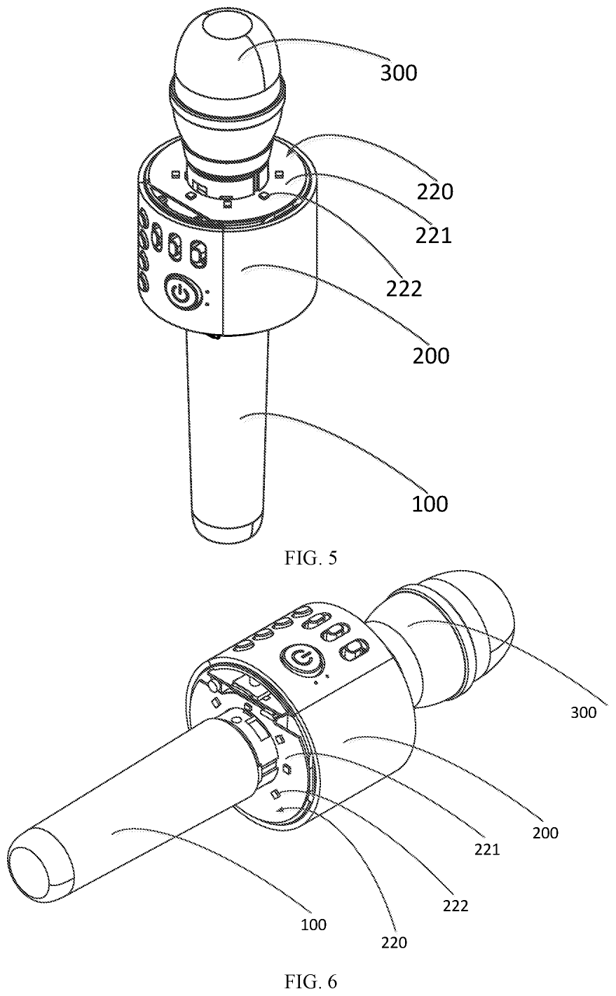

In particular, referring to FIG. 5, which is a schematic diagram illustrating the structure of the microphone shown in FIG. 1 with the upper transparent cover removed.

The light-emitting assembly 220 provided on the top surface 202 may include a second circuit board 221 in an annular shape, and a plurality of light-emitting elements 222 may be arranged on the annular second circuit board 221, and the plurality of light-emitting elements 222 may be sequentially arranged at equal intervals along the perimeter of the annular second circuit board 221.

Referring to FIG. 6, which shows a schematic diagram illustrating the structure of the microphone shown in FIG. 1 with the lower transparent cover removed.

Similarly, the light-emitting assembly 220 arranged on the bottom surface 203 may also include a second circuit board 221 in an annular shape, and a plurality of light-emitting elements 222 may be arranged on the annular second circuit board 221, and the plurality of light-emitting elements 222 may be sequentially arranged at equal intervals along the perimeter of the annular second circuit board 221.

In the light-emitting assemblies 220 respectively provided on the top surface 202 and the bottom surface 203, the line connecting the centers of the multiple light-emitting elements 222 in each set of the light-emitting elements 220 may form a circle.

Further, in this embodiment, the handle portion 100 is provided with a power supply assembly 110 and a charging interface (not shown in the figures), wherein the charging interface can be electrically connected to the power supply assembly 110, and the charging interface may be used to electrically connect to an external power source so as to charge the power supply assembly 110. The power supply assembly 110 may be electrically connected to the first circuit board and the light-emitting assemblies 220 to supply power to the first circuit board and the light-emitting assemblies 220.

In this embodiment, a sound cavity 101 is defined in the microphone 10, and a loudspeaker 240 is arranged in the sound cavity 101, where the loudspeaker 240 may also be electrically connected to the first circuit board. Optionally, the second circuit boards 221 in the light-emitting assemblies 220 arranged on the four side surfaces 201, the top surface 202, and the bottom surface 203 of the control portion 200 may all be attached to the outer wall of the sound cavity 101, and the light-emitting elements 222 on each second circuit board 221 may be arranged on the side of the second circuit board 221 away from the exterior surface of the sound cavity 101.

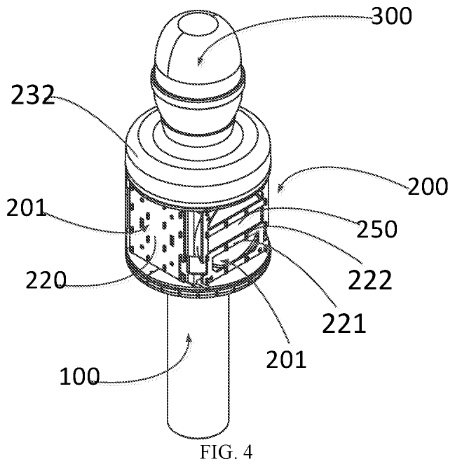

Further referring to FIGS. 4 and 7, where FIG. 7 is a schematic diagram illustrating the structure of the microphone shown in FIG. 4 after further removing the light-emitting assemblies.

Each second circuit board 221 may also define a fixing hole 2211, and a fixing post 102 may also be provided on the outer wall of the sound cavity 101. When the second circuit board 221 is attached to the outer wall of the sound cavity 101, the fixing post 102 on the outer wall may be inserted into the fixing hole 2211 so as to fix the position of the second circuit board 221. In this solution, the disassembly and assembly of each second circuit board 221 is easy and convenient.

Alternatively or additionally, the second circuit board 221 may also be provided with a snap hole, and a fixing buckle 103 may be provided on the outer wall of the sound cavity 101, and the fixing buckle 103 may be caught in the snap hole of the second circuit board 221, thereby clamping and fixing the second circuit board 221. In this solution, the second circuit board 221 can be fixed to the outer wall of the sound cavity 101 without using other fasteners, and its installation and disassembly are easy and convenient.

Furthermore, in this embodiment, a diaphragm 250 is also provided in the sound cavity 101.

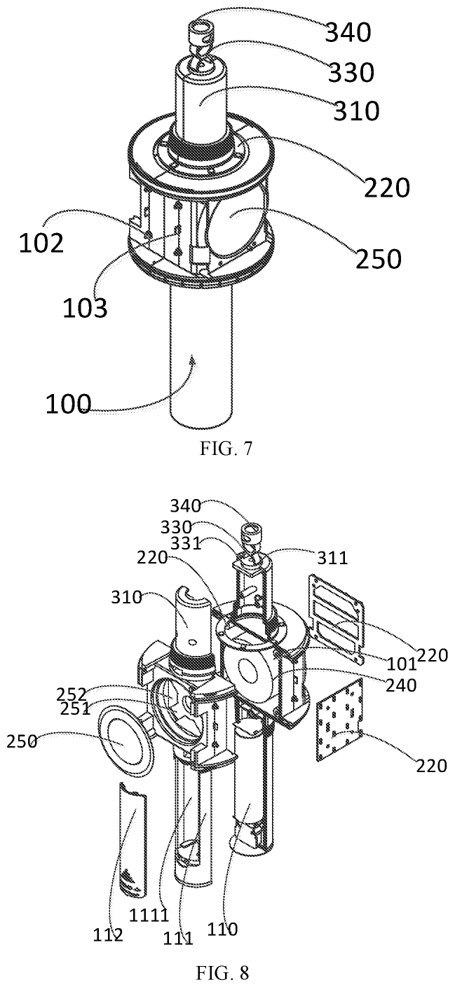

In particular, further referring to FIGS. 4 and 8, where FIG. 8 is an exploded view of the microphone shown in FIG. 4.

In this embodiment, the loudspeaker 240 is fixed in the sound cavity 101, and a bracket 251 is also provided on one side of the loudspeaker 240. The bracket 251 is fixedly installed on the inner wall of the sound cavity 101 and adjacent to the loudspeaker 240. The diaphragm 250 is installed on the bracket 251.

Therefore, in the present application, by providing the diaphragm 250, when the loudspeaker 240 is working, the air vibration caused by the sound inside the sound cavity 101 of the microphone 10 may resonate with the diaphragm 250, which can enhance the stereoscopic effect of the music when the singer is singing.

A groove 252 is in turn arranged on the side of the bracket 251 away from the loudspeaker 240. The groove 252 may communicate with the sound cavity 101, and the diaphragm 250 may cover the opening position of the groove 252.

Further, in this embodiment, the microphone head 300 includes a support seat 310, a mic net cover 320, a mic holder 330, and a mic element 340.

The support seat 310 is connected to the outer wall of the sound cavity 101. The microphone bracket 330 is connected to the support seat 310 on the side away from the sound cavity 101. The mic element 340 is installed on the side of the mic holder 330 away from the sound cavity 101, and the mic net cover 320 is disposed to at least cover the mic element 340.

The support seat 310 may be assembled by two halves, and the microphone bracket 330 may be detachably installed with the support seat 310. For example, a support groove 311 may be provided on the top of the two halves of the support seat 310. When the two halves are assembled to form the support seat 310, the support groove 311 on the top of the two halves may enclose an installation space. At this time, the fixing portion 331 of the mic holder 330 may be accommodated in the installation space, and the part of the mic holder 330 outside the installation space may be used to fix the installation head 340.

In this embodiment, the mic net cover 320 may be fixedly connected to the upper transparent cover 232 (for example, it may be screwed up by a threaded structure, or connected by a fastener such as a screw, or bonded by an adhesive such as glue).

The mic element 340 may be electrically connected to the first circuit board 220. In this embodiment, the mic element 340 may be used to generate a fluctuating current signal in response to the sound waves generated when the user utters. The fluctuating current signal generated may then be transmitted to the first circuit board and processed by the functional circuit on the first circuit board. After that, the processed fluctuating current signal may be further transmitted to the loudspeaker 240, so that the loudspeaker 240 makes a sound in response to the fluctuating current signal.

In this embodiment, the mic holder 330 may be formed by flexible materials such as silicone. Therefore, the mic holder 330 can effectively reduce the howling in the sound, reduce the noise, improve the purity of the sound during singing, and increase the sound effect, thus providing the singer with a better singing experience.

Further referring to FIG. 8. In this embodiment, the handle portion 100 of the microphone 10 may also include a handle housing 111 and a cover 112. The handle housing 111 may be assembled using two halves, and an accommodating space may be defined in the handle housing 111 assembled by two halves. The accommodating space may be used for installing the power supply assembly 110.

In this embodiment, a window 1111 may be further provided in the handle housing 111, and the cover 112 may be detachably at the position of the window 1111 to close the window 1111. Therefore, when the cover 112 is closed at the position where the window 1111 is opened, the power supply assembly 110 can be put in the accommodating space of the handle housing 111. When the cover 112 is removed from the position where the window 1111 is opened, the power supply assembly 110 in the accommodating space of the handle housing 111 can be exposed for maintenance or replacement of the power supply.

In view of the foregoing, the present application provides a microphone, which uses multiple light-emitting assemblies that are arranged in the control portion. When in use, the color of the light emitted by the light-emitting assembly and the brightness of the light-emitting assembly can be automatically changed according to the microphone song or through the control button, so that the multiple light-emitting assemblies of the microphone can illuminate in a preset manner, thereby improving the aesthetics of the microphone when in use, and providing rich visual effects. In addition, when the user uses this microphone to sing, the atmosphere during singing can be effectively increased, so that the comfort of the singer and the listener is enhanced, leading to high market competitiveness and practicability, Furthermore, in the solution of the present application, by setting the diaphragm and the mic holder, when the loudspeaker is working, the air vibration in the sound cavity of the microphone can resonate with the diaphragm, thus enhancing the three-dimensional sensation of the music when the singer sings. The mic holder can effectively reduce the howling in the sound, reduce the noise, improve the purity of the sound of singing, increase the sound effect, and provide a better singing experience for the singer.

The foregoing merely depicts some illustrative embodiments of the present application, which are not intended to limit the scope of the present disclosure. Any equivalent structural to process changes made on the basis of the contents of the description and drawings of the present disclosure or any direct or indirect use of the present disclosure on other related technical fields shall all be included in the scope of protection of the present disclosure.

1. A microphone, comprising a handle portion, a control portion, and a microphone head, which are connected in succession;
wherein the control portion comprises: a first circuit board, a second circuit board and a plurality of light-emitting assemblies arranged along a perimeter of the control portion;
the control portion further comprises a sound cavity, wherein a loudspeaker is arranged in the sound cavity and is electrically connected to the first circuit board, and the second circuit board is fixed to outer wall of the sound cavity; and
the first circuit board is electrically connected to the plurality of light-emitting assemblies and configured for controlling the plurality of light-emitting assemblies to emit light in a preset light-emitting mode.

2. The microphone of claim 1, wherein the control portion comprises two sets of parallel side surfaces, a top surface and a bottom surface arranged in parallel with the top surface, the top surface and the bottom surface are connected to the two sets of parallel side surfaces, and the light-emitting assembly is arranged on at least one of the side surfaces.

3. The microphone of claim 2, wherein the light-emitting assembly is arranged on at least one of the top surface or the bottom surface.

4. The microphone of claim 2, wherein each of the side surfaces of the control portion is provided with the light-emitting assembly.

5. The microphone of claim 1, wherein the control portion further comprises a control button that is electrically connected to the first circuit board and that is configured to control the light-emitting mode of the plurality of light-emitting assemblies.

6. The microphone of claim 5, wherein the light-emitting mode of the plurality of light-emitting assemblies comprises that the plurality of light-emitting assemblies emit light in sequence.

7. The microphone of claim 6, wherein light-emitting mode comprises that only one light-emitting assembly is turned on at a time, and the plurality of light-emitting assemblies take turns to emit light, or one of the light-emitting assembly is controlled to emit light and keeps turned on before another light-emitting assembly is controlled to emit light and keeps turned on, and so on till the last of the light-emitting assemblies.

8. The microphone of claim 5, wherein the first control board is configured to control the plurality of light-emitting assemblies to emit light and form a preset pattern, which is operative to be switched according to at least one selected from the group consisting of a style of a song, a tune, and lyrics.

9. The microphone of claim 5, wherein the first control board is configured to control ON and OFF of the plurality of light-emitting assemblies to form a luminous effect of a breathing lamp.

10. The microphone of claim 5, wherein the plurality of light-emitting assemblies comprise a plurality of light-emitting elements of different colors, and wherein the light-emitting mode comprises that the light-emitting elements of different colors emit light in succession, or the plurality of light-emitting assemblies each emit light of a different color.

11. The microphone of claim 1, wherein the microphone further comprises a protective mesh cover sleeved on the control portion, and the light-emitting assemblies are exposed through meshes of the protective mesh cover.

12. The microphone of claim 5, wherein the light-emitting assembly comprises a light-emitting element arranged on the second circuit board; and
wherein the light-emitting element is a light-emitting diode.

13. The microphone of claim 5, wherein the handle portion comprises a power supply assembly and a charging interface, wherein the power supply assembly is electrically connected to the first circuit board and the light-emitting assemblies and configured for supplying power to the first circuit board and the light-emitting assemblies; and
the charging interface is electrically connected to the power supply assembly, and is configured to electrically connect to an external power source to charge the power supply assembly.

14. (canceled)

15. The microphone of claim 14, wherein the microphone head comprises a support seat, a mic net cover, a mic holder, and a mic element, wherein the support seat is connected to the sound cavity, and the mic holder is connected to a side of the support seat away from the sound cavity, wherein the microphone is installed on a side of the mic holder away from the sound cavity, and the mic net cover at least covers the mic element.

16. The microphone of claim 12, wherein the second circuit board defines a fixing hole, and a corresponding fixing post is arranged on an outer wall of a sound cavity, and wherein the fixing post is operative to be inserted into the fixing hole to fix the second circuit board to the outer wall of the sound cavity.

17. The microphone of claim 12, wherein the second circuit board defines a snap hole, and a corresponding fixing buckle is arranged on an outer wall of a sound cavity, and wherein the fixing buckle is operative to be caught in the snap hole of the second circuit board, thereby catching and fixing the second circuit board to the outer wall of the sound cavity.

18. The microphone of claim 15, wherein the mic holder is made of a flexible material.

19. The microphone of claim 18, wherein the flexible material comprises silicone.

20. The microphone of claim 1, wherein the handle portion comprises a handle housing and a cover, wherein the handle housing is assembled using two halves, and wherein an accommodating space is defined in the handle housing and configured for installing a power supply assembly.
